(19) United States
(12) Patent Application Publication
(10) Pub. No.: US 2008/0101493 A1
(43) Pub. Date: May 1, 2008

(54) Method and system for computing a spatial spreading matrix for space-time coding in wireless communication systems

(75) Inventors: Huaning Niu, Sunnyvale, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/588,716

(22) Filed: Oct. 27, 2006

(51) Int. Cl. H04L 1/02

(52) U.S. Cl. 375/267

(57) ABSTRACT

A method and system for wireless communication over a wireless channel combines space-time coding with statistical transmit beamforming. As such, instantaneous channel state information is not required. In one implementation, statistical beamforming is performed by employing an optimal spreading matrix as a function of a transmit correlation matrix, without requiring instantaneous channel state information.

### FIELD OF THE INVENTION

The present invention relates to space-time coding (STC) in wireless communication systems, and in particular, to computing and utilizing a spatial spreading matrix for space-time block coding (STBC) in wireless communication systems.

### BACKGROUND OF THE INVENTION

In wireless communication systems, channel fading and intersymbol interference (ISI) lead to performance degradation. To mitigate fading, space-time coding techniques have exploited diversity and coding gain over multiple-input-multiple-output (MIMO) fading channels. To mitigate ISI, orthogonal frequency division multiplexing (OFDM) has been utilized. Further, a combination of STC and OFDM (i.e., STC-OFDM), has been used in broadband wireless applications such as in IEEE 802.11n communication systems.

In such existing MIMO STC-OFDM communication systems, information bits are convolutionally encoded with a rate ½ coding, from which other rates are derived by puncturing. Punctured bits are spatially parsed to generate several spatial streams using round robin cycling. Each spatial stream is interleaved in the frequency domain and mapped to constellation points with Gray labeling by quadrature amplitude modulation (QAM) mapping, to generate QAM symbols. The resulting QAM symbols may be encoded by STBC, and are mapped to subcarriers using an inverse Fast Fourier Transform (IFFT) function to generate time domain signals. A cyclic delay function is also utilized to explore delay diversity provided by a plurality of available transmitter antennas. Pilot tones are inserted in the frequency domain, while a cyclic prefix is inserted in the time domain, to generate transmit streams. The transmit streams are transmitted over the plurality of transmitter antennas to a receiver with multiple receiver antennas.

However, such existing MIMO STC-OFDM communication systems assume a multipath channel model in which fading from each transmitter antenna to any receiver antenna is uncorrelated. Such assumption is valid only in a rich scattering environment. As a result, downlink transmission performance from the transmitter to the receiver suffers due to fading in environments without rich scattering.

### BRIEF SUMMARY OF THE INVENTION

The present invention provides a method and a system for applying STC to data transmission by beamforming between a wireless transmitter and a wireless receiver using statistical channel information. In one embodiment, applying STC to data transmission by beamforming according to the present invention includes converting incoming data into a plurality of spatial data streams, applying STC to the spatial data streams to generate coded spatial data streams, and performing transmit beamforming on the coded spatial data streams based on statistical channel information. Preferably, applying STC to the spatial data streams includes applying STBC to the spatial data streams.

In accordance with further features of the present invention, performing beamforming on the coded spatial data streams further includes performing statistical beamforming on the coded spatial data streams. According to an embodiment of the present invention, performing statistical beamforming on the coded spatial data streams (i.e., statistical STC-beamforming) includes applying spatial spreading to the coded spatial data streams using an optimal spreading matrix that is based on statistical channel information. Such statistical STC-beamforming using an optimal spatial spreading matrix provides the benefits of both beamforming gain and space-time coding gain.

In one embodiment of the present invention, the statistical channel information includes at least a transmit correlation matrix, wherein the optimal spreading matrix is determined as a function of the transmit correlation matrix. The optimal spreading matrix is applied to the STBC encoded data streams to generate transmit streams for transmission. The transmit streams are transmitted over a plurality of transmitter antennas to a receiver using delay diversity. The transmit streams are received at the receiver via a plurality of receiver antennas, wherein the receiver performs space-time decoding on the received streams.

These and other features, aspects and advantages of the present invention will become understood with reference to the following description, appended claims and accompanying figures.

### BRIEF DESCRIPTION OF THE DRAWINGS

FIG. 1 shows a functional block diagram of a wireless MIMO STC-OFDM transmitter that is configured to perform STBC and beamforming with spatial spreading for wireless communication, according to an embodiment of the present invention.

FIG. 2 shows a flowchart of the steps in determining an optimal spreading matrix, according to an embodiment of the present invention.

FIG. 3 shows a functional block diagram of a wireless MIMO STC-OFDM receiver, corresponding to the transmitter of FIG. 1, according to an embodiment of the present invention.

FIG. 4 shows a graph illustrating the performance of the transmitter of FIG. 1 for an IEEE 802.11n channel model B with 16 QAM, ½ coding down-link MIMO STC-OFDM wireless communication, according to an embodiment of the present invention, in comparison with that of conventional transmitters.

FIG. 5 shows a graph illustrating the performance of the transmitter of FIG. 1 for an IEEE 802.11n channel model D with 16 QAM, ½ coding down-link MIMO STC-OFDM wireless communication, according to an embodiment of the present invention, in comparison with that of conventional transmitters.

FIG. 6 shows a graph illustrating the performance of the transmitter of FIG. 1 for an IEEE 802.11n channel model B with 64 QAM, ¾ coding down-link MIMO STC-OFDM wireless communication, according to an embodiment of the present invention, in comparison with that of conventional transmitters.

FIG. 7 shows a graph illustrating the performance of the transmitter of FIG. 1 for an IEEE 802.11n channel model D with 64 QAM, ¾ coding down-link MIMO STC-OFDM wireless communication, according to an embodiment of the present invention, in comparison with that of conventional transmitters.

### DETAILED DESCRIPTION OF THE INVENTION

The present invention provides a method and a system for applying STC to data transmission by beamforming between a wireless transmitter and a wireless receiver using statistical channel information. According to an embodiment of the present invention, STC is combined with beamforming, wherein statistical channel information is used to determine an optimal spatial spreading matrix that enables statistical beamforming.

In one example of statistical STC-beamforming according to the present invention, incoming data is converted to a plurality of spatial data streams, and then STC is applied to the spatial data streams to generate multiple coded spatial data streams. Then, transmit beamforming is performed on the coded spatial data streams using statistical channel information to generate transmit streams. The transmit streams are then transmitted to the receiver over a wireless channel.

Preferably, applying STC to the spatial data streams includes applying STBC to the spatial data streams and then performing beamforming.

The optimal spreading matrix functions as a spatial matrix for statistical transmit beamforming. The optimal spreading matrix is determined based on statistical channel information including at least a transmit correlation matrix. As such, instantaneous channel state information is not required at the transmitter. This further enables implementation of statistical STC-beamforming with spatial spreading in OFDM applications, according to an embodiment of the present invention.

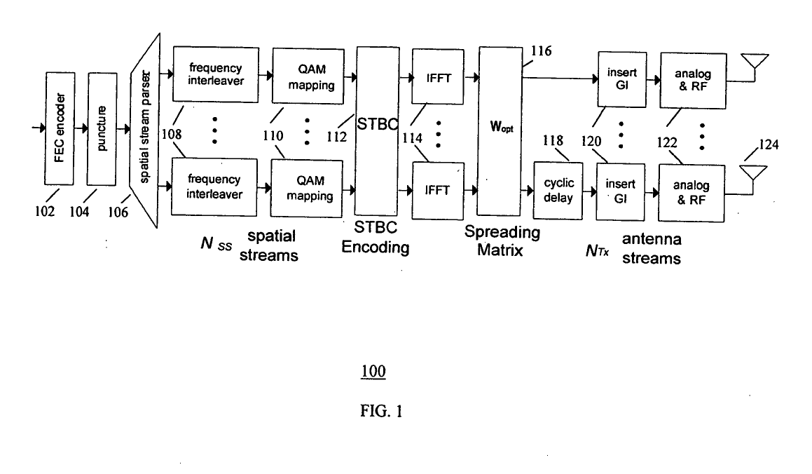

FIG. 1 shows a functional block diagram of an example MIMO-OFDM transmitter 100, according to an embodiment of the present invention. The transmitter 100 implements statistical STC-beamforming by combining STBC with statistical transmit beamforming using an optimal spatial spreading matrix, according to an embodiment of the present invention.

The transmitter 100 comprises a forward error correction (FEC) encoder 102, a puncturer 104, a spatial stream parser 106, multiple (Nss) frequency interleavers 108, multiple (Nss) QAM mappers 110, a STBC encoder 112, multiple IFFT functions 114, a steering beamformer comprising a spreading function 116, multiple (N_{TX}-1) cyclic delay 118, multiple (N_{TX}) guard interval (GI) insertion functions 120, multiple (N_{TX}) analog and radio frequency (RF) functions 122, and multiple (N_{TX}) transmitter antennas 124.

The FEC encoder 102 encodes an input data such as a physical layer convergence protocol (PLCP) service data unit (PSDU), into an encoded data stream. The puncturer 104 punctures the encoded data stream into a punctured data stream. The FEC encoder 102 provides convolutional encoding of rate ½, from which other rates are derived by puncturing in the puncturer 104.

The spatial stream parser 106 parses the punctured data stream into multiple (Nss) spatial streams using round robin cycling. Each spatial stream then passes through a corresponding frequency interleaver 108 for bit interleaving, and each interleaved stream is input to a corresponding QAM mapper 110 for mapping to constellation points with Gray labeling to generate QAM symbols. The resulting QAM symbols are input into the STBC encoder 112 for STBC coding to generate multiple STBC coded streams. The number of STBC coded streams depends on the STBC scheme selected, and can be any number that is greater than or equal to Nss, and less than or equal to N_{TX}. Although in the example herein STBC is utilized, as those skilled in the art will recognize, the present invention is useful with other encoding schemes such as space-time trellis coding (STTC).

Each STBC coded stream is then mapped to a subcarrier by a corresponding IFFT function 114 to generate a corresponding number of time domain signals. The spreading function 116 then applies a spreading matrix W to the time domain signals to generate multiple (N_{TX}) antenna streams, thereby matching the encoded spatial streams to the available transmit antennas 124. The spreading matrix W also provides statistical transmit beamforming, acting as a beamforming steering matrix in the spreading function 116.

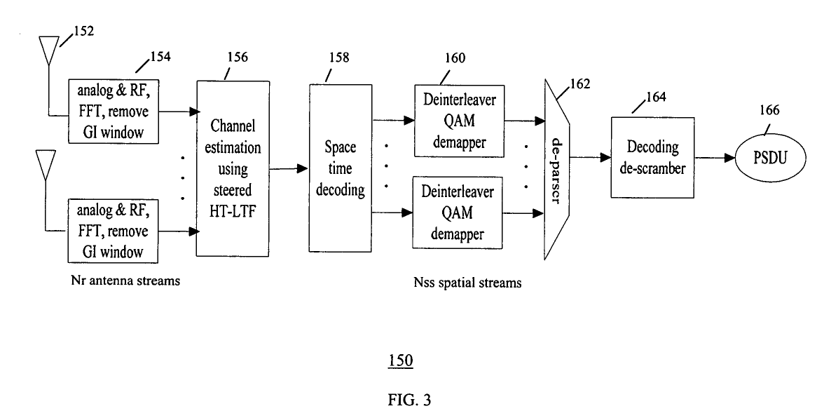

Then the cyclic delay function 118 explores the delay diversity provided by the antennas 124. Each GI insertion function 120 then applies guard intervals to a corresponding antenna stream. Further, each analog and RF function 122 applies digital-to-analog conversion to a corresponding antenna stream and upconverts a resulting baseband analog signal to an RF signal for transmission via a corresponding transmit antenna 124 to a wireless receiver (e.g., FIG. 3) over a wireless channel.

In order to generate a spreading matrix W, a performance criterion based on a pairwise error probability is first derived. Then, optimum spatial spreading vectors, for generating an optimal spatial spreading matrix are obtained by minimizing the error probability. An optimal spreading matrix is then derived using statistical channel information wherein only the second order channel statistics is utilized, without requiring instantaneous channel state information at the transmitter.

Accordingly, in one implementation, the wireless channel is modeled as:

Hᵥ=Rᵣ^{1/2}H_{iid}Rₜ^{1/2},

wherein Rᵣ^{1/2} and Rₜ^{1/2} represent receive and transmit correlation matrices, respectively, and

H_{iid} is a matrix of an independent zero mean, a unit variance, and complex Gaussian random variables.

The receive and transmit correlation matrices Rᵣ^{1/2} and Rₜ^{1/2}, respectively, are assumed to be the same for different paths of a multipath fading environment. Therefore, the optimal spreading matrix Wₒₚₜ is determined as:

Wₒₚₜ=Q⁺,

wherein Q⁺ is the right singular vector of Rₜ^{1/2}.

The optimal spreading matrix Wₒₚₜ is applied to the time domain signals by the spreading function 116. In this way, the transmitter 100 essentially does not place constraints on the STBC scheme implemented by the STBC encoder 112.

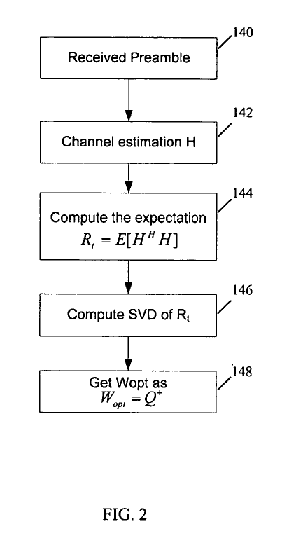

FIG. 2 shows a flowchart of a procedure 130 for determining the optimal spreading matrix Wₒₚₜ, including the steps of:
Step 140: Receive signaling preamble information.
Step 142: Estimate the channel matrix H to determine channel statistical information.
Step 144: Compute a transmit correlation matrix (expectation value) as Rₜ=E[H^{H}H].
Step 146: Compute a singular value decomposition (SVD) for Rₜ.
Step 148: Compute Wₒₚₜ=Q⁺, wherein Q⁺ comprises the right singular vectors of Rₜ resulting from the singular value decomposition.

The optimum spatial spreading matrix is the same for all subcarriers in the example STC-beamforming OFDM transmitter 100 (FIG. 1), thus allowing a time domain signal processing implementation which reduces both transmitter and receiver complexity.

FIG. 3 shows a functional block diagram of a MIMO STC-OFDM wireless receiver 150, corresponding to the transmitter of FIG. 1, according to an embodiment of the present invention. The receiver 150 comprises multiple (Nr) receive antennas 152, multiple (Nr) stream processors 154, a channel estimator 156, a space-time decoder 158, multiple deinterleaver-QAM demappers 160, a de-parser 162, and a decoder and de-scrambler 164.

The receiver 150 receives the transmitted signals from the transmitter 100 via the receiver antennas 152 for processing by the corresponding stream processors 154. Each stream processor 154 processes a signal from a corresponding receiver antenna 152 by applying: RF to baseband conversion, analog-to-digital conversion, FFT processing, and GI window removal, as is known to those skilled in the art. As such, the received signals are sampled and down-converted to Nr baseband antenna stream digital signals.

The channel estimator 156 inputs the antenna streams and estimates the channel H using steered high throughput long preamble (HT-LTF) signaling fields in the Nr baseband antenna stream digital signals, to output estimated channel state information for the channel H. The space-time decoder 158 then generates Ns data streams based on the output of the channel estimator 156, by performing the reverse function of the space-time encoder 112 of the transmitter 100. The Nss data streams are then processed by the corresponding Nss deinterlaver-QAM demappers 160 for constellation de-mapping (i.e., de-mapping constellation points to soft bit information), and reshuffling the de-mapped soft bit information for decoding.

The de-parser 162 then de-multiplexes the Nss data streams from the Nss deinterleaver QAM de-mappers 160 back into one decoded stream for Viterbi decoding by the decoder and de-scrambler 164 to generate a PSDU 166.

In one example scenario, a wireless device A (e.g., the transmitter 100 in FIG. 2) desires to transmit to a wireless device B (e.g., the receiver 150 in FIG. 3), using an optimal spatial spreading matrix according to an embodiment of the present invention. The wireless device A first receives statistical channel information from the wireless device B. Then, the wireless device A uses the received statistical channel information to calculate an optimal spatial spreading matrix as a beamforming steering matrix. Then, the wireless device A transmits to the wireless device B by beamforming using the calculated optimal spatial spreading matrix as the steering matrix.

As such, the steps in the flowchart of FIG. 2 above involve both the transmitter 100 (FIG. 1) and the receiver 150 (FIG. 3). Specifically, the steps 140 and 142 in FIG. 2 are implemented by the receiver processing function 154 which determines channel statistical information by estimation, and feeds back that information to the transmitter. Further, the steps 144, 146, 148 in FIG. 2 are performed by the spreading function 116 of the transmitter to determine an optimal spatial spreading matrix as the steering matrix for beamforming transmissions from the transmitter to the receiver over the wireless channel.

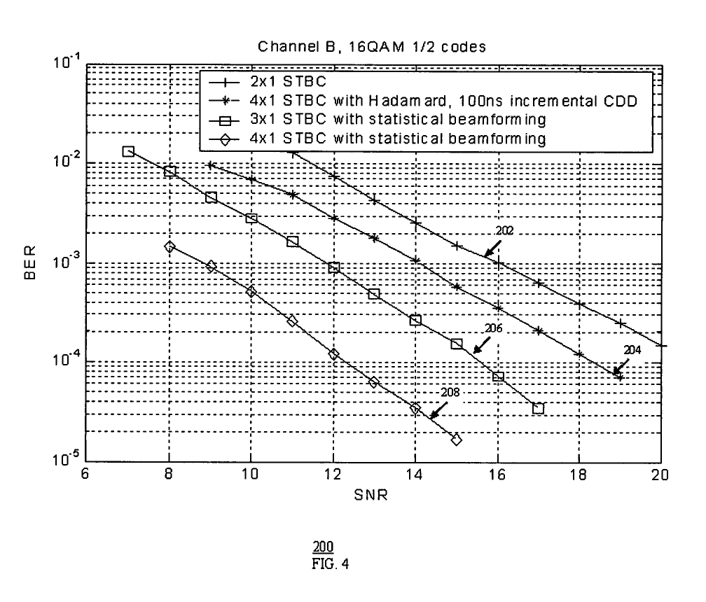

In accordance with further features of the present invention, the wireless transmitter 100 and the wireless receiver 150 form components of a wireless MIMO-OFDM communication system utilizing statistical STC-beamforming, according to an embodiment of the present invention. FIGS. 4-7 compare simulated performance of example implementations of such a wireless communication system using optimal spatial spreading, according to the present invention versus conventional wireless communication systems implementing baseband STBC and Hadamard spreading. The simulations are for a 20 MHz MIMO system with 64 subcarriers and 0.8 ps GI for the IEEE 802.11n wireless channel models B and D, as described below. The channel model B is a two-tap channel with 15 ns rms (root mean square) delay spread, while the channel model D is a nine-tap channel with 50 ns rms delay spread. Exponential delay is applied to each channel path.

Referring to FIG. 4, a graph 200 shows simulation result curves 202, 204, 206 and 208 indicating the bit error rate (BER) over a non-line-of-sight (NLOS) channel model B with 16 QAM and ½ coding rate. The curves 202 and 204 show simulated performance of example conventional wireless systems, while curves 206 and 208 show simulated performance of example wireless systems according to the present invention. Specifically, the curve 202 shows a conventional base-line 2x1 STBC application (as indicated by the legend in FIG. 4), wherein two adjacent transmitter antennas are selected out of four available antennas for transmissions to a receiver.

The curve 204 shows the performance of a conventional 4x1 STBC application with conventional spatial spreading, wherein the first two columns of a Hadamard matrix are used to map two data streams to four transmitter antennas. A 100 ns incremental cyclic delay (CDD) is also applied on each transmitter antenna to increase the delay diversity. The 4x1 STBC application (curve 204) provides approximately a 2 dB performance improvement over the base-line 2x1 STBC application (curve 202), due to a higher delay diversity.

The curve 206 shows the performance of a 3x1 STBC application with an optimal spatial spreading vector (i.e., Wₒₚₜ calculated above), according to an embodiment of the present invention. Compared to the 4x1 Hadamard spreading case (curve 204), the 3x1 STBC application with an optimal spatial spreading vector (curve 206) provides approximately an additional 2 dB performance improvement (curve 206), even with one less antenna.

The curve 208 shows the performance of a 4x1 STBC application with an optimal spatial spreading vector (matrix) Wₒₚₜ according to an embodiment of the present invention. The curve 208 illustrates an approximate 6 dB performance improvement over the 4x1 Hadamard spreading application (curve 204), and approximately an 8 dB gain over the 2x1 base-line application (curve 202).

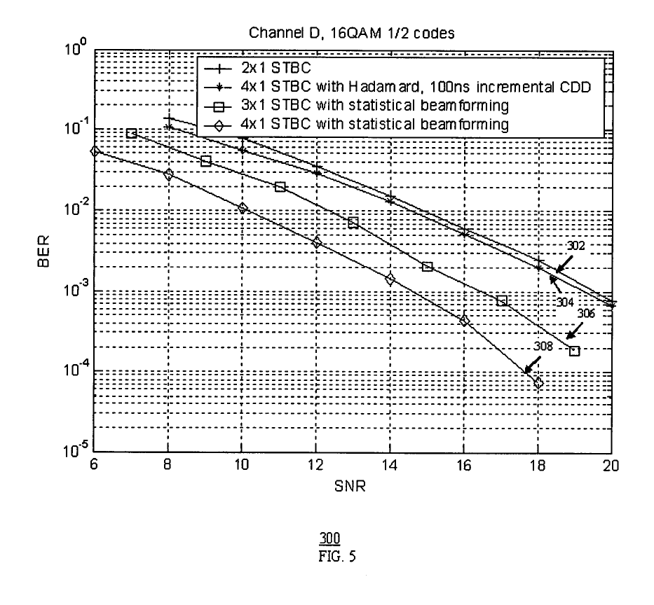

Referring to FIG. 5, a graph 300 shows simulation result curves 302, 304, 306 and 308 corresponding to the curves 202, 204, 206 and 208 in FIG. 4, respectively, but illustrating BER over a NLOS channel model D with 16 QAM and ½ coding rate. In FIG. 5, any additional delay diversity introduced by cyclic delay is no longer effective because the channel model D is a highly frequency selective channel. Therefore, in a 4x1 Hadamard spreading application (curve 304), marginal performance improvement over a base-line 2x1 STBC application (curve 302) is observed.

The curves 306 and 308 show simulation results for 3x1 and 4x1 STBC example applications, respectively, using optimal spreading vectors according to the present invention. As the curves 306 and 308 illustrate, the 3x1 and 4x1 STBC example applications according to the present invention provide approximately a 2.5 dB and a 4.5 dB performance improvement, respectively, over the conventional approaches represented by the curves 302 and 304.

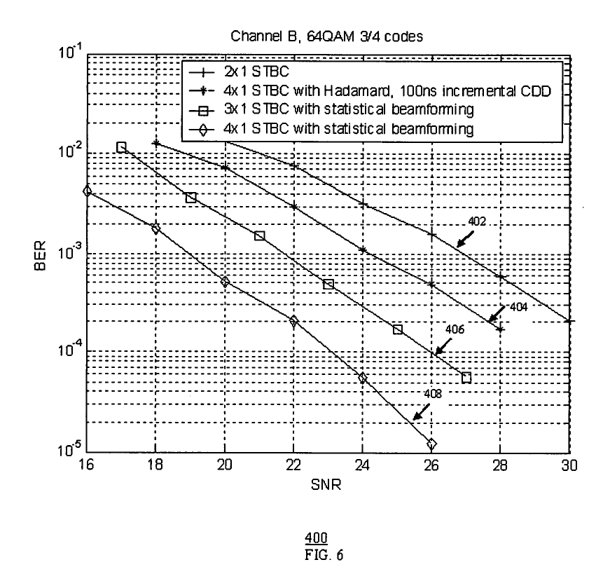

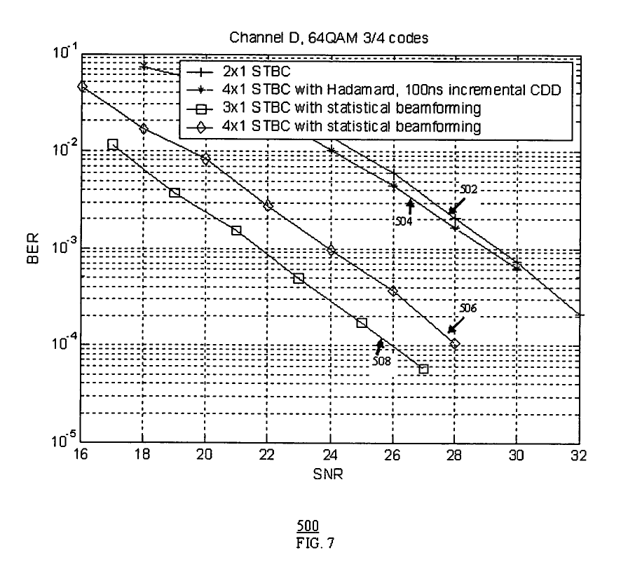

Referring to FIG. 6, a graph 400 shows simulation result curves 402, 404, 406 and 408 corresponding to the curves 202, 204, 206 and 208 in FIG. 4, respectively, but illustrating BER over a NLOS channel model B with a 64 QAM and ¾ coding rate. Similarly, a graph 500 in FIG. 7 shows simulation result curves 502, 504, 506 and 508 corresponding to the curves 202, 204, 206 and 208 in FIG. 4, respectively, but illustrating BER over a NLOS channel model D with a 64 QAM and ¾ coding rate. Notably, FIGS. 6 and 7 indicate similar results as FIGS. 4 and 5 for 64 QAM with ¾ coding over the channel models B and D, respectively. This demonstrates that optimal spatial spreading according to an embodiment of the present invention is effective and robust to channel delay spreads and correlations in fading channels.

In general, the overall performance improvement using optimal spatial spreading vectors according to the present invention may be less pronounced in the channel model D applications compared to the channel model B application. This is because the channel model B has a higher transmission correlation, wherein the highest eigenvalue is larger than that of the channel model D.

A wireless communication system implementing space-time coding and statistical beamforming using an optimal spatial spreading matrix based on the principles of the present invention provides the benefits of both space-time coding gain and beamforming gain. This reduces system complexity for both the transmitter and the receiver. Further SNR (signal-to-noise ratio) gain introduced by such statistical beamforming provides better error performance than conventional STC-OFDM methods.

As is known to those skilled in the art, the aforementioned example architectures described above, according to the present invention, can be implemented in many ways, such as program instructions for execution by a processor, as logic circuits, as an ASIC, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of wireless communication over a wireless channel, comprising the steps of:
generating a plurality of spatial data streams;
space-time coding the spatial data streams to generate coded spatial data streams; and
performing transmit beamforming on the coded spatial data streams based on statistical channel information.

2. The method of claim 1 wherein the step of space-time coding the spatial data streams includes space-time block coding the spatial data streams.

3. The method of claim 1 wherein the step of performing transmit beamforming further includes applying spatial spreading to the coded spatial data streams based on the statistical channel information.

4. The method of claim 3 wherein:
the statistical channel information includes a transmit correlation matrix; and
the step of applying spatial spreading further includes the steps of applying spatial spreading to the coded spatial data streams based on the transmit correlation matrix.

5. The method of claim 4 wherein the step of applying spatial spreading further includes:
determining an optimal spatial spreading matrix as a function of said transmit correlation matrix; and
applying spatial spreading to the coded spatial data streams using the optimal spatial spreading matrix, to generate multiple transmit streams.

6. The method of claim 5 wherein the step of determining an optimal spatial spreading matrix further includes determining the optimal spatial spreading matrix as a function of said transmit correlation matrix based on statistical channel information.

7. The method of claim 5 further comprising the step of:
transmitting the multiple transmit streams over multiple transmitter antennas of a transmitter by beamforming steering based on the optimal spatial spreading matrix.

8. The method of claim 7 further comprising the steps of:
receiving the transmitted streams at a receiver; and
performing space-time decoding on the received streams.

9. The method of claim 1 wherein the step of space-time coding the spatial data streams further includes space-time trellis coding the spatial data streams.

10. A method of wireless communication in a wireless communication system, comprising the steps of:
generating a plurality of spatial data streams for transmission over multiple antennas of a transmitter via a wireless channel;
space-time coding the spatial data streams to generate coded spatial data streams; and
performing statistical beamforming on the coded spatial data streams, by:
determining an optimal spatial spreading matrix as a function of statistical channel information including a transmit correlation matrix; and
applying spatial spreading to the coded spatial data streams using the optimal spatial spreading matrix to generate a plurality of transmit streams.

11. The method of claim 10 wherein the step of determining an optimal spatial spreading matrix further includes:
obtaining performance criterion based on a pairwise error probability; and
obtaining optimum spatial spreading vectors by minimizing the error probability.

12. The method of claim 10 wherein the step of determining an optimal spatial spreading matrix further includes the steps of:
modeling the channel as:
Hᵥ=Rᵣ^{1/2}H_{iid}Rₜ^{1/2},
wherein Rᵣ^{1/2} and Rₜ^{1/2} are receive and transmit correlation matrices, respectively, and H_{iid} is a matrix of an independent zero mean, a unit variance, and complex Gaussian random variables; and
determining the optimal spatial spreading matrix, Wₒₚₜ, by calculating:
Wₒₚₜ=Q⁺,
wherein Q⁺ is the right singular vectors of Rₜ^{1/2}.

13. The method of claim 12 wherein the receive correlation matrix Rᵣ^{1/2} and the transmit correlation matrix Rₜ^{1/2} are the same for different transmit antenna paths.

14. The method of claim 10 wherein the step of determining an optimal spatial spreading matrix further comprises:
determining a transmit correlation matrix Rₜ based on a channel matrix H, by computing Rₜ=E[H^{H}H];
computing a singular value decomposition for Rₜ; and
determining the optimal spatial spreading matrix, Wₒₚₜ by calculating:
Wₒₚₜ=Q⁺,
wherein Q⁺ represents the right singular vectors of Rₜ resulting from the singular value decomposition.

15. The method of claim 10 wherein the communication system comprises a MIMO-OFDM wireless communication system.

16. The method of claim 10 wherein the communication system is a type of IEEE 802.11n communication system.

17. The method of claim 10 further comprising the step of:
transmitting the plurality of transmit streams over the multiple transmit antennas using delay diversity.

18. The method of claim 10 wherein the step of space-time coding the spatial data streams further includes space-time trellis coding the spatial data streams.

19. The method of claim 10 wherein the step of space-time coding the spatial data streams further includes space-time block coding the spatial data streams.

20. The method of claim 10 further comprising the steps of:
receiving the transmit streams at a receiver; and
performing space-time decoding on the received transmissions.

21. The method of claim 20 further comprising the step of receiving the statistical channel information from the receiver.

22. A wireless transmitter comprising:
a parser that is configured to generate a plurality of spatial data streams from input data for transmission over a wireless channel;
a space-time coder that is configured to perform space-time coding on the spatial data streams to generate coded spatial data streams; and
a beamformer that is configured to perform transmit beamforming on the coded spatial data streams based on statistical channel information.

23. The transmitter of claim 22 wherein the space-time coder is further configured to perform space-time block coding on the spatial data streams.

24. The transmitter of claim 22 wherein the beamformer comprises a spatial spreading function that is configured to apply spatial spreading to the coded spatial data streams based on the statistical channel information.

25. The transmitter of claim 24 wherein:
the statistical channel information includes a transmit correlation matrix; and
the spatial spreading function is further configured to apply spatial spreading to the coded spatial data streams based on the transmit correlation matrix.

26. The transmitter of claim 25 wherein the spatial spreading function is further configured to determine an optimal spatial spreading matrix as a function of said transmit correlation matrix, and apply spatial spreading to the coded spatial data streams using the optimal spatial spreading matrix, to generate multiple transmit streams.

27. The transmitter of claim 25 wherein the spatial spreading function is further configured to determine an optimal spatial spreading matrix by determining the optimal spatial spreading matrix as a function of said transmit correlation matrix based on statistical channel information, without requiring instantaneous channel state information.

28. The transmitter of claim 26 wherein the spatial spreading function is further configured to:
determine the optimal spatial spreading matrix by modeling the channel as:
Hᵥ=Rᵣ^{1/2}H_{iid}Rₜ^{1/2},
wherein Rᵣ^{1/2} and Rₜ^{1/2} are receive and transmit correlation matrices, respectively, and H_{iid} is a matrix of an independent zero mean, a unit variance, and complex Gaussian random variables; and
determine the optimal spatial spreading matrix, Wₒₚₜ, by calculating:
Wₒₚₜ=Q⁺,
Q⁺ is the right singular vectors of Rₜ^{1/2}.

29. The transmitter of claim 28 wherein the receive correlation matrix Rᵣ^{1/2} and the transmit correlation matrix Rₜ^{1/2} are the same for different transmit antenna paths.

30. The transmitter of claim 26 wherein the spatial spreading function is further configured to:
determine a transmit correlation matrix Rₜ based on a channel matrix H, by computing Rₜ=E[H^{H}H]; and
determine the optimal spatial spreading matrix, Wₒₚₜ, by calculating Wₒₚₜ=Q⁺, wherein Q⁺ represents the right singular vectors of Rₜ.

31. The transmitter of claim 22 wherein the space-time coder is further configured to perform space-time trellis coding on the spatial data streams.

32. A wireless communication system comprising:
a wireless transmitter comprising:
a parser that is configured to generate a plurality of spatial data streams from input data;
a space-time coder that is configured to perform space-time coding on the spatial data streams to generate coded spatial data streams; and
a beamformer that is configured to perform transmit beamforming on the coded spatial data streams based on statistical channel information for transmission over a wireless channel; and
a wireless receiver comprising a space-time decoder that is configured to decode transmissions received from the transmitter.

33. The system of claim 32 wherein the space-time coder is further configured to perform space-time block coding on the spatial data streams.

34. The system of claim 32 wherein the beamformer comprises a spatial spreading function that is configured to apply spatial spreading to the coded spatial data streams based on the statistical channel information.

35. The system of claim 34 wherein:
the statistical channel information includes a transmit correlation matrix; and
the spatial spreading function is further configured to apply spatial spreading to the coded spatial data streams based on the transmit correlation matrix.

36. The system of claim 35 wherein the spatial spreading function is further configured to determine an optimal spatial spreading matrix as a function of said transmit correlation matrix, and apply spatial spreading to the coded spatial data streams using the optimal spatial spreading matrix, to generate multiple transmit streams.

37. The system of claim 36 wherein the spatial spreading function is further configured to:
determine the optimal spatial spreading matrix by modeling the channel as:
Hᵥ=Rᵣ^{1/2}H_{iid}Rₜ^{1/2},
wherein Rᵣ^{1/2} and Rₜ^{1/2} are receive and transmit correlation matrices, respectively, and H_{iid} is a matrix of an independent zero mean, a unit variance, an complex Gaussian random variables; and
determine the optimal spatial spreading matrix, Wₒₚₜ, by calculating:
Wₒₚₜ=Q⁺,
wherein Q⁺ is the right singular vectors of Rₜ^{1/2}.

38. The system of claim 37 wherein the receive correlation matrix Rᵣ^{1/2} and the transmit correlation matrix Rₜ^{1/2} are the same for different transmit antenna paths.

39. The system of claim 36 wherein the spatial spreading function is further configured to:
determine a transmit correlation matrix Rₜ based on a channel matrix H, by computing Rₜ=E[H^{H}H]; and
determine the optimal spatial spreading matrix, Wₒₚₜ, by calculating Wₒₚₜ=Q⁺, wherein Q⁺ represents the right singular vectors of Rₜ.

40. The system of claim 36 wherein the receiver further includes an estimator that is configured to determine channel statistical information and provide the channel statistical information to the transmitter.

41. The system of claim 40 wherein the beamformer is further configured to transmit the multiple transmit streams over multiple transmitter antennas of the transmitter by beamforming steering based on the optimal spatial spreading matrix.

42. A wireless receiver for receiving transmissions form a transmitter over a wireless channel, comprising:
a channel information estimator that is configured to determine statistical channel information and provide the statistical channel information back to the transmitter;
a space-time decoder that is configured to receive space-time coded transmissions from the transmitter and decode the space-time coded transmissions into multiple data streams.

43. The receiver of claim 42 further comprising a channel estimation module that is configured to receive multiple transmission streams from the transmitter, and generate estimated channel state information based on statistically steered high throughput long preamble (HT-LTF) signaling fields in the transmission streams.

44. The receiver of claim 43 wherein the space-time decoder is further configured to utilize the estimated channel state information in decoding the space-time coded transmissions.

45. The receiver of claim 42 wherein the space-time decoder is further configured to perform space-time block decoding on the space-time coded transmissions.

46. The receiver of claim 42 wherein the space-time decoder is further configured to perform space-time trellis decoding on the space-time coded transmissions.
